(19) United States
(12) Patent Application Publication
(10) Pub. No.: US 2013/0260722 A1
(43) Pub. Date: Oct. 3, 2013

(54) ANTI-THEFT SYSTEM FOR MOBILE ELECTRONIC DEVICE AND METHOD THEREOF

(71) Applicants: INVENTEC APPLIANCES (PUDONG) CORPORATION, Shanghai (CN); INVENTEC APPLIANCES CORP., New Taipei City (TW); INVENTEC APPLIANCES (SHANGHAI) CO. LTD., Shanghai City (CN)

(72) Inventor: Ben-Yuan Pi, Shanghai (CN)

(73) Assignees: INVENTEC APPLIANCES (PUDONG) CORPORATION, Shanghai (CN); INVENTEC APPLIANCES (SHANGHAI) CO. LTD., Shanghai City (CN); INVENTEC APPLIANCES CORP., New Taipei City (TW)

(21) Appl. No.: 13/844,843

(22) Filed: Mar. 16, 2013

(30) Foreign Application Priority Data
Mar. 29, 2012 (CN) 201210087218.6

(51) Int. Cl. H04W 12/08

(52) U.S. Cl. CPC H04W 12/08
USPC 455/411

(57) ABSTRACT

An anti-theft system applicable to a portable electronic device is provided in the present invention. The anti-theft system includes an input unit, a storage unit and a processing unit. The input unit is configured to receive code information. The storage unit is configured to store a first operating system, a second operating system and predetermined code information. The processing unit is configured to compare the code information with the predetermined code information. When the code information matches the predetermined code information, the processing unit enables the first operating system. When the code information does not match the predetermined code information, the processing unit enables the second operating system.

### FIELD OF THE INVENTION

The present invention relates to an anti-theft system for a mobile electronic device and a method thereof, and more particularly relates to an anti-theft system for a mobile electronic device capable of determining whether the code information inputted by the user matches or not to enable the operating system or encrypt the user information, and a method thereof.

### BACKGROUND OF THE INVENTION

In present, mobile electronic devices, such as notebooks (NBs), ultra mobile personal computers (UMPCs), personal digital assistants (PDAs) and smart phones, are usually the target for theft because of the high price tag. In addition, with the feature of small size and light weight, the success rate is usually high.

It is quite popular for users to use the smart phones outside, such as when taking a public transportation or in the coffee shop, library and etc. The risk of being stolen is high because the smart phone is light and handy, and easy to be stored.

### BRIEF SUMMARY OF INVENTION

An anti-theft system applicable to a mobile electronic device, such as a smart phone, and a method thereof are provided in the present invention. The anti-theft system determines the correct user by using the code information inputted by the user. If the code information is not correct, user information will be encrypted to protect the information of the owner of the smart phone and the location of the smart phone will be traced to make it easier to find out the stolen smart phone.

An anti-theft system applicable to a portable electronic device is provided in the present invention. The anti-theft system includes an input unit, a storage unit and a processing unit. The input unit is configured to receive code information. The storage unit is configured to store a first operating system, a second operating system, and predetermined code information. The processing unit is configured to compare the code information and the predetermined code information. When the code information matches the predetermined code information, the processing unit enables the first operating system. When the code information does not match the predetermined code information, the processing unit enables the second operating system.

In accordance with an embodiment of the present invention, the processing unit transmits position information of the mobile electronic device to a server through a network.

In accordance with an embodiment of the present invention, the anti-theft system has a satellite positioning unit configured to obtain the position information of the mobile electronic device.

In accordance with an embodiment of the present invention, the server transmits the position information to a user-defined device after receiving the position information.

In accordance with an embodiment of the present invention, the storage unit is further configured to store user information. When the processing unit enables the second operating system, the processing unit encrypts the user information.

In accordance with an embodiment of the present invention, the first operating system is an ordinary operating system, and the second operating system is a virtual operating system.

An anti-theft method applicable to a portable electronic device is also provided in the present invention. The portable electronic device has a first operating system, a second operating system and predetermined code information stored therein. Firstly, code information is compared with the predetermined code information. Then, when the code information matches the predetermined code information, the first operating system is enabled. When the code information does not match the predetermined code information, the second operating system is enabled.

In accordance with an embodiment of the present invention, the step of enabling the second operating system further comprises transmitting position information of the portable electronic device to a server through a network.

In accordance with an embodiment of the present invention, wherein the portable electronic device comprises a satellite positioning unit configured to produce the position information.

In accordance with an embodiment of the present invention, wherein the step of enabling the second operating system further comprises transmitting the position information to a user-defined device.

In accordance with an embodiment of the present invention, wherein the step of enabling the second operating system further comprises encrypting user information.

### BRIEF DESCRIPTION OF THE DRAWINGS

FIG. 1 is a block diagram showing an anti-theft system in accordance with an embodiment of the present invention.

FIG. 2 is a block diagram showing an anti-theft system in accordance with another embodiment of the present invention.

FIG. 3 is a flow chart showing an anti-theft method applicable to a smart phone as shown in FIG. 2 in accordance with a preferred embodiment of the present invention.

### DETAILED DESCRIPTION OF THE INVENTION

The embodiments adopted in the present invention would be further discussed by using the flowing paragraph and the figures for a better understanding.

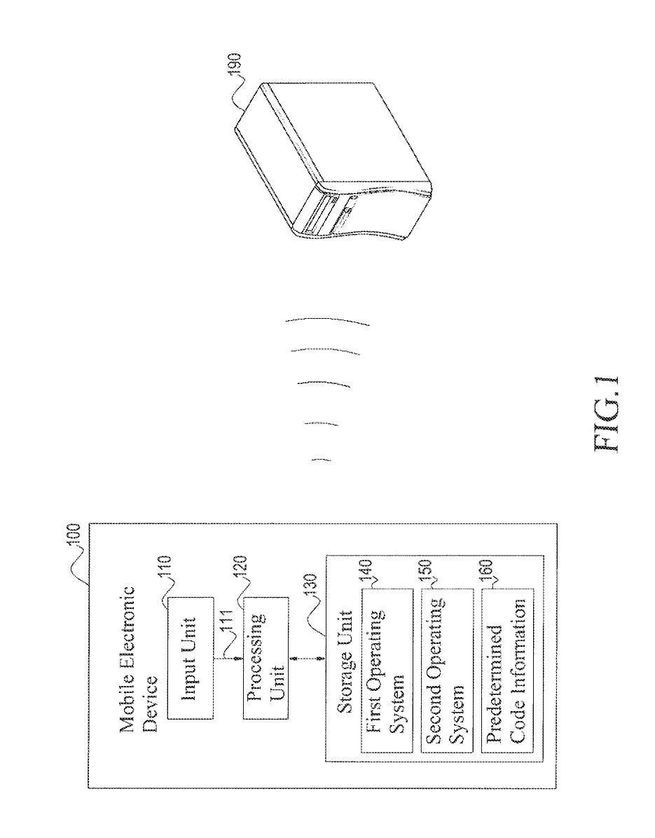

FIG. 1 is a block diagram showing an anti-theft system applicable to a mobile electronic device in accordance with an embodiment of the present invention. As shown, the anti-theft system is located in a mobile electronic device 100. The anti-theft system includes an input unit 110, a processing unit 120 and a storage unit 130. The input unit 110 is configured to receive code information 111. The code information 111 may contain English letters, numbers, face features of a user, fingerprint features, a predetermined graphic, a predetermined gesture or a combination of the above mentioned information. The storage unit 130 is configured to store a first operating system 140, a second operating system 150, and predetermined code information 160. The processing unit 120 is configured to compare the code information 111 with the predetermined code information 160. When the code information 111 matches the predetermined code information 160, the processing unit 120 enables the first operating system 140, and when the code information 111 does not match the predetermined code information 160, the processing unit 120 enables the second operating system 150 and transmits position information of the mobile electronic device to a server 190 through a network.

Upon the code information 111 containing English letters or numbers, the processing unit 120 may compare the identity of the code information 111 with the predetermined English letters or numbers. Upon the code information 111 containing face features of a user, the processing unit 120 may include a facial recognition system for analyzing relative position, size, or shape of the eyes, nose, cheekbones, and jaw with the predetermined face features. Upon the code information 111 containing fingerprint features of a user, the processing unit 120 may include a fingerprint recognition system for analyzing patterns of fingerprint ridges with the predetermined fingerprint. Upon the code information 111 containing a predetermined graphic, the processing unit 120 may compare the path of the code information 111 with the predetermined graphic. Upon the code information 111 containing a predetermined gesture, the processing unit 120 may compare sensed motion with the predetermined gesture.

In the present embodiment, the processing unit 120 may communicates with a server 190 through a network for transmitting the position information to the server. Thus, the user may trace the location of the mobile electronic device 100.

In the present embodiment, the anti-theft system may also have a satellite positioning unit (not shown) disposed on the mobile electronic device which is configured to obtain the position information of the mobile electronic device.

In the present embodiment, the server 190 may further transmit the position information to an user-defined device 290, such as another mobile phone, computer or notebook, after receiving the position information.

In the present embodiment, the storage unit 130 may also store user information. When the processing unit 120 enables the second operating system 150, the processing unit 120 encrypts the user information simultaneously. The user information may be the login password of the first operating system 140, the information stored in the first operating system 140, or the settings or configurations of the first operating system 140.

In the present embodiment, the first operating system 140 may be an ordinary operating system, which is the typical operating system for the computer devices, and the second operating system 150 may be a virtual operating system.

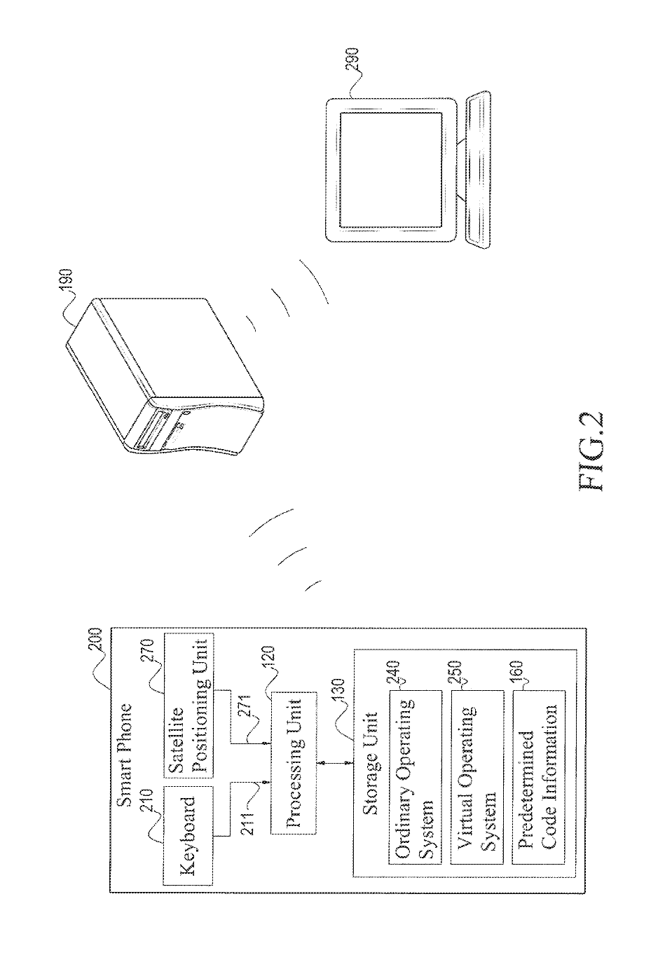

FIG. 2 is a block diagram showing an anti-theft system in accordance with another embodiment of the present invention. As shown in FIG. 2, the anti-theft system is located in a smart phone 200, which includes a keyboard 210, a processing unit 120, a storage unit 130, and a satellite positioning unit 270.

As a preferred embodiment, the keyboard 210 may be a virtual keyboard on the touch screen. The user may input user password 211 through the keyboard 210. The storage unit 130 stores an ordinary operating system 240, a virtual operating system 250, and a predetermined code information 160. The processing unit 120 compares the user password 211 inputted by the user with the predetermined code information 160. When the user password 211 matches the predetermined code information 160, the processing unit 120 enables the ordinary operating system 240. When the user password 211 does not match the predetermined code information, the processing unit 120 enables the virtual operating system 250, accesses position information 271 of the smart phone 200 by using the satellite positioning unit 270 of the smart phone 200, and transmits the position information 271 to a server through a network. The position information 271 is then transmitted to the user's personal computer 290.

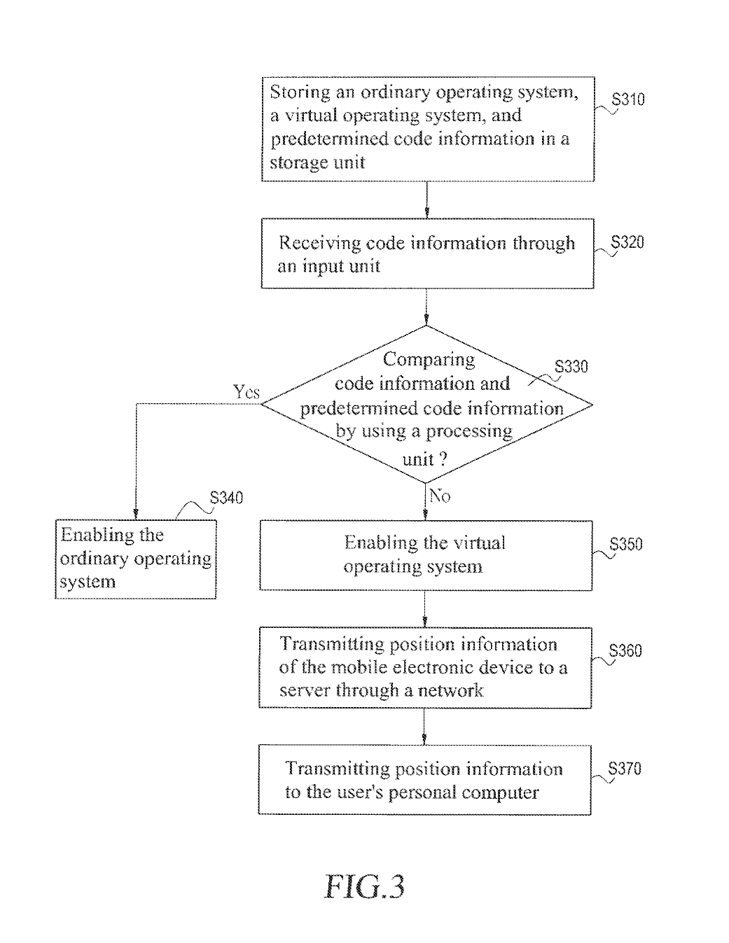

FIG. 3 is a flow chart showing an anti-theft method applicable to a smart phone in accordance with another embodiment of the present invention. As shown, the method comprises the steps as mentioned below.

In step S310, an ordinary operating system, a virtual operating system, and predetermined code information are stored in a storage unit.

In step S320, code information is received through an input unit.

In step S330, the code information and the predetermined code information are compared by using a processing unit.

In step S340, when the code information matches the predetermined code information, the ordinary operating system is enabled.

In step S350, when the code information does not match the predetermined code information, the virtual operating system is enabled.

In the present embodiment, user information may be further encrypted by using the processing unit.

In step S360, position information of the mobile electronic device is transmitted to a server through a network. In the present embodiment, the position information of the mobile electronic device may be obtained by using a satellite positioning unit.

In step S370, the position information is transmitted to the user's personal computer. In the present embodiment, other than the personal computer, the position information may be transmitted to other user-defined devices, such as notebook, UMPC, PDA, and smart phone.

In conclusion, the anti-theft system provided in the present invention is capable of protecting user information from being stolen and providing position information of the smart phone for the user to search the stolen smart phone. In addition, the smart phone has a real user's interface and a virtual user's interface stored therein. If user authentication process fails, the virtual interface would be displayed and the user information would be encrypted to prevent the theft to access user's personal data stored in the smart phone.

The detail description of the aforementioned preferred embodiments is for clarifying the feature and the spirit of the present invention. The present invention should not be limited by any of the exemplary embodiments described herein, but should be defined only in accordance with the following claims and their equivalents. Specifically, those skilled in the art should appreciate that they can readily use the disclosed conception and specific embodiments as a basis for designing or modifying other structures for carrying out the same purposes of the present invention without departing from the scope of the invention as defined by the appended claims.

What is claimed is:

1. An anti-theft system, applicable to a portable electronic device, comprising:
an input unit, configured to receive code information;
a storage unit, configured to store a first operating system, a second operating system and predetermined code information; and
a processing unit, configured to compare the code information with the predetermined code information, wherein when the code information matches the predetermined code information, the processing unit enables the first operating system, and when the code information does not match the predetermined code information, the processing unit enables the second operating system.

2. The anti-theft system of claim 1, wherein the processing unit is further configured to transmit position information of the portable electronic device to a server through a network when the code information does not match the predetermined code information.

3. The anti-theft system of claim 2, wherein the portable electronic device has a satellite positioning unit which is configured to obtain the position information of the portable electronic device.

4. The anti-theft system of claim 2, wherein the server transmits the position information to a user-defined device after receiving the position information.

5. The anti-theft system of claim 1, wherein the storage unit is further configured to store user information, and when the processing unit enables the second operating system, the processing unit encrypts the user information.

6. The anti-theft system of claim 1, wherein the first operating system is an ordinary operating system, and the second operating system is a virtual operating system.

7. An anti-theft method, applicable to a portable electronic device with a first operating system, a second operating system and predetermined code information stored therein, comprising:
comparing code information with the predetermined code information;
when the code information matches the predetermined code information, enabling the first operating system; and
when the code information does not match the predetermined code information, enabling the second operating system.

8. The anti-theft method of claim 7, wherein the step of enabling the second operating system further comprises:
transmitting position information of the portable electronic device to a server through a network.

9. The anti-theft method of claim 8, wherein the portable electronic device comprises a satellite positioning unit configured to produce the position information.

10. The anti-theft method of claim 8, wherein the step of enabling the second operating system further comprises:
transmitting the position information to a user-defined device.

11. The anti-theft method of claim 7, wherein the step of enabling the second operating system further comprises:
encrypting user information.
